(19) United States
(12) Patent Application Publication
(10) Pub. No.: US 2009/0292527 A1
(43) Pub. Date: Nov. 26, 2009

(54) Methods, Apparatuses and Computer Program Products for Receiving and Utilizing Multidimensional Data Via A Phrase

(75) Inventors: John William Russell Anderson, London (GB); Marko Balabanovic, London (GB); Samuel Paul Dean, London (GB); Christopher Scott Gathercole, Bedfordshire (GB)

Correspondence Address: Alston & Bird LLP;Bank of America Plaza, 101 South Tryon Street, Suite 4000, Charlotte, NC, 28280-4000, US

(73) Assignee: Travelocity.com LP

(21) Appl. No.: 12/125,332

(22) Filed: May 22, 2008

(51) Int. Cl. G06F 17/27

(52) U.S. Cl. 704/9

(57) ABSTRACT

Methods, apparatuses and computer program products are provided for receiving multidimensional data via a phrase. In this regard, various exemplary embodiments may guide a user in defining a phrase on a segment-by-segment basis. Recommendations may be provided to the user to guide the user in defining the segment to thereby define the phrase. Upon defining the phrase, the phrase may be parsed into one or more segments. The parsed segments may provide information about the phrase, and content associated with the parsed segments may be linked to data fields of, for example, a search engine or database. Using the linked data fields, operations may be performed with respect to the phrase including searches for data or storage of data.

### FIELD OF THE INVENTION

Embodiments of the present invention relate generally to information entry and, more particularly, relate to methods, apparatuses and computer program products for receiving and utilizing multidimensional data via a phrase.

### BACKGROUND OF THE INVENTION

Over the past few decades, communicating information has become increasingly important in both business and personal settings. The ease and speed of communication between users of electronic devices is at the forefront of many technological advances. Many of the recent advances in communications target communications between the users of electronic devices, including, for example, text messaging, instant messaging, cellular telephone technologies, and voice-over internet protocol technologies (VoIP). While these user-to-user communication interfaces continue to advance, however, advancements to user-to-device communications seem to lag behind.

Users have come to accept that communication with electronic devices is often dictated by the electronic device, instead of by the user. However, from the first punch card reader to speech recognition technologies, developers and manufacturers of electronic devices have endeavored to find ways for electronic devices to “understand” the user. Unfortunately, interactions between users and electronic devices are still ultimately limited by the simplistic behavior and binary aspects of electronic devices and users have reluctantly accepted these limitations. For example, users have accepted that a search engine will return all the documents or web pages that contain the search terms provided by the user regardless of the intent of the user or the authors of documents or webpages. Users have also accepted the fact that data entry into forms and spreadsheets involves clicking on appropriate fields and typing appropriate content into the fields.

Despite the limitations of electronic devices, improvements in user-to-device communications are possible and are highly desirable. Improvements to user-to-device communications can positively affect operations such as general data entry, or searching and retrieving data functions. As such, a need exists for improved mechanisms for user-to-device communications. In particular, a need exists for users to be able to communicate with electronic devices in a manner that is comfortable to the average user, but still intelligible to the electronic device.

### BRIEF SUMMARY OF THE INVENTION

Methods, apparatuses and computer program products are provided for receiving multidimensional data via a phrase. In this regard, various exemplary embodiments may guide a user in defining a phrase on a segment-by-segment basis. Recommendations may be provided to the user to guide the user in defining each successive segment to thereby define the phrase. Upon defining the phrase, the phrase may be parsed into one or more segments. The parsed segments may provide information about the phrase, and content associated with the parsed segments may be linked to data fields of, for example, a search engine or database. Using the linked data fields, operations may be performed with respect to the phrase including searches for data or storage of data.

In one exemplary embodiment of the present invention, a method for receiving and utilizing multidimensional data via a phrase is provided. The method may include receiving one or more characters of an undefined segment of a phrase including the undefined segment and one or more defined segments, each segment including one or more collections of characters having a user-defined meaning; providing one or more recommendations for defining the undefined segment, the recommendations being selected based on the received one or more characters of the undefined segment and a context of the one or more defined segments in the phrase; the recommendations being provided without regard to any previously received phrase including the same one or more defined segments; and receiving one of the recommendations to thereby define the undefined segment and the phrase.

In another exemplary embodiment of the present invention, an apparatus for receiving and utilizing multidimensional data via a phrase is provided. The apparatus may include a processor. The processor may be configured to receive one or more characters of an undefined segment of a phrase including the undefined segment and one or more defined segments, each segment including one or more collections of characters having a user-defined meaning; provide one or more recommendations for defining the undefined segment, the recommendations being selected based on the received one or more characters of the undefined segment and a context of the one or more defined segments in the phrase; the recommendations being provided without regard to any previously received phrase including the same one or more defined segments; and receive one of the recommendations to thereby define the undefined segment and the phrase.

In another exemplary embodiment of the present invention, a computer program product for receiving and utilizing multidimensional data via a phrase is provided. The computer program product may include at least one computer-readable storage medium having computer-readable program code portions stored therein. The computer-readable program code portions may include a first executable configured to receive one or more characters of an undefined segment of an undefined phrase including the undefined segment and one or more defined segments, each segment including one or more collections of characters having a user-defined meaning; a second executable portion configured to provide one or more recommendations for defining the undefined segment, the recommendations being selected based on the received one or more characters of the undefined segment and a context of the one or more defined segments in the phrase; the recommendations being provided without regard to any previously received phrase including the same one or more defined segments; and a third executable portion configured to receive one of the recommendations to thereby define the undefined segment and the phrase.

### BRIEF DESCRIPTION OF THE SEVERAL VIEWS OF THE DRAWING(S)

Having thus described exemplary embodiments of the present invention in general terms, reference will now be made to the accompanying drawings, which are not necessarily drawn to scale, and wherein:

FIG. 1 is a block diagram of a computing system according to various exemplary embodiments of the present invention;

FIGS. 2a-2g are illustrations of a data entry field for a phrase used to perform searches according to various exemplary embodiments of the present invention;

FIGS. 3a-3c are illustrations of a data entry field for a phrase used to perform searches according to various exemplary embodiments of the present invention;

FIG. 4 is an illustration of a data entry field for a phrase used to submit data to a database according to various exemplary embodiments of the present invention;

FIG. 5 is an illustration of phrase parsing and linking according to various exemplary embodiments of the present invention; and

FIG. 6 is a flow chart of a method for generating a phrase and performing an operation with respect to the phrase according to various exemplary embodiments of the present invention.

### DETAILED DESCRIPTION OF THE INVENTION

Exemplary embodiments of the present invention will now be described more fully hereinafter with reference to the accompanying drawings, in which some, but not all embodiments of the present invention are shown. Indeed, the present invention may be embodied in many different forms and should not be construed as limited to the exemplary embodiments set forth herein; rather, these exemplary embodiments are provided so that this disclosure will satisfy applicable legal requirements. Like reference numerals refer to like elements throughout.

Exemplary embodiments of the present invention generally relate to the use of multidimensional data in the form of a phrase to perform operations, such as querying or searching data, and general data entry. Various exemplary embodiments may assist, or guide, a user as the phrase is defined, and perform operations based on the content of the resulting phrase. To facilitate performance of operations based with respect to the phrase, the phrase may be parsed into one or more segments.

As explained herein, a phrase may include one or more segments. A segment may include content and a context with respect to the phrase. The content of a segment may be any expression of meaningful information such as one or more linguistic sentences, portions of a linguistic sentence (e.g., linguistic clauses), collections of characters (e.g., linguistic words, slang terms, Internet slang terms, netspeak terms, abbreviations such as airport codes), or other expressions having a user-recognizable meaning. For example, according to various embodiments, the expression “I would like a hotel on Friday in Paris” may define a phrase. The content of the phrase may be divided, or parsed into segments of data. The segments may include, “I would like a,” “hotel,” “on Friday,” and “in Paris.” Similarly, “paris on Friday” may define a phrase. In this regard, the segments may be “paris” and “on Friday.”

The context of a segment may refer to the relationship between the segment and the remainder of the phrase including that segment, and may be based on other segments within the phrase and/or the position of the segment within the phrase.

As a phrase is defined, exemplary embodiments of the invention can provide recommendations for segment content to suggestively guide a user toward a multidimensional phrase, i.e., a phrase containing various types of information that may be intelligible to an electronic device and a user. Recommendations for segment content can be selected based upon the content of other segments in the phrase and the context of the respective segment within the phrase. A user may add recommended content, or content consistent with a recommended content type, to a segment to thereby define the segment and accordingly define the phrase.

When a phrase is defined, i.e., when all required information is present in the phrase, a user may initiate an operation with respect to the phrase. The phrase may then be parsed into its segments, and information may be derived from the segments. Information derived from the segments may be used to determine, for example, search engines, search forms, databases or the like that should be connected to perform an operation, a category of the search, or other attributes of the operation to be undertaken. For example, if a segment includes the content “flight,” the information derived from this segment may indicate that a search of travel product websites should be performed and a category for the search may be flights.

The contents of the parsed segments may also be linked to data fields in, for example, a search engine, search form, database, or the like to facilitate performing an operation with respect to the phrase. Upon linking content of the segments to data fields, one or more operations (e.g., search, store, etc.) may be undertaken. In this regard, search operations may include searches for travel products (e.g., hotels, flights, holidays, travel guides, etc.), retail products (e.g. books, gifts), services, or the like. Similarly, embodiments of the present invention may also be utilized to enter data into one or more data servers. In this manner and as described further herein, multidimensional data within a phrase can be received and utilized to perform appropriate operations.

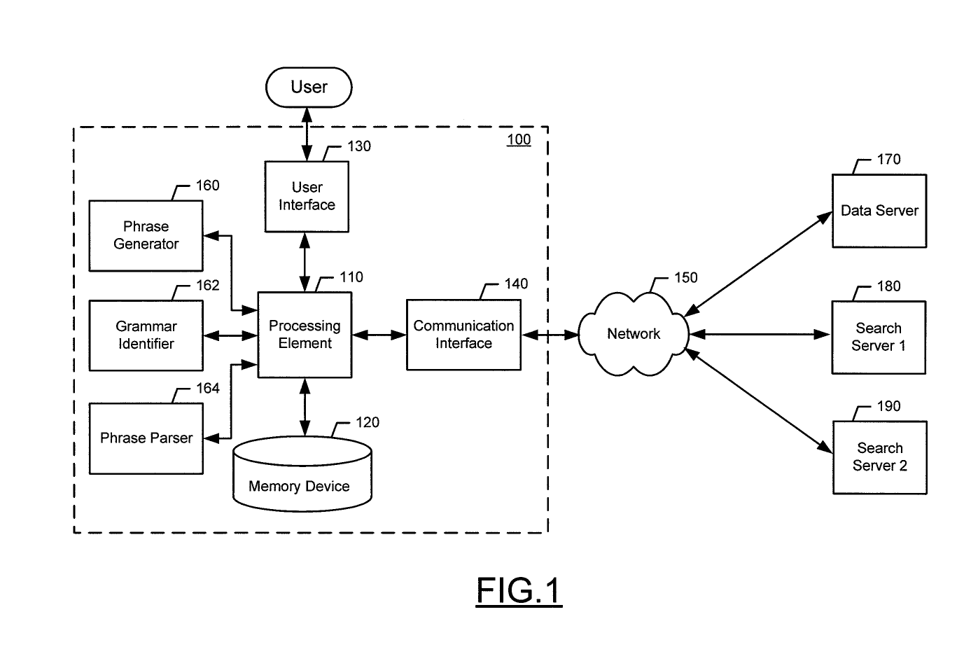

An exemplary embodiment of the present invention will now be described with reference to FIG. 1, in which certain elements of apparatus 100 for enabling phrase content entry are shown. Apparatus 100 of FIG. 1 may be embodied as or otherwise employed, for example, on a network device such as a computer, terminal, mobile terminal (e.g., mobile/cellular phone, portable digital assistants (PDAs), pagers, mobile televisions, gaming devices, or the like), server, such as a search server or data server, or the like. It should be noted that while apparatus 100 illustrates one example of a configuration of an apparatus for enabling phrase content entry, numerous other configurations may also be used to implement exemplary embodiments of the present invention.

As shown, apparatus 100 may include or otherwise be in communication with processing element 110, user interface 130, communication interface 140 and memory device 120. Memory device 120 may include, for example, volatile and/or non-volatile memory. Memory device 120 may be configured to store information, data, applications, instructions, or the like for enabling apparatus 100 to carry out various functions in accordance with exemplary embodiments of the present invention. For example, memory device 120 may be configured to buffer input data for processing by processing element 110. Additionally or alternatively, memory device 120 could be configured to store instructions for execution by processing element 110. As yet another alternative, memory device 120 may be one of a plurality of databases that store information in the form of static and/or dynamic information.

Processing element 110 may be embodied in a number of different ways. For example, processing element 110 may be embodied as a processor, a coprocessor, a controller or various other processing means or devices including integrated circuits such as, for example, an ASIC (application specific integrated circuit) or FPGA (field programmable gate array). Various exemplary embodiments, processing element 110 may be configured to execute instructions stored in memory device 120 or otherwise accessible to processing element 110.

Communication interface 140 may be embodied as any device or means embodied in either hardware, software, or a combination of hardware and software that is configured to receive and/or transmit data from/to a network 150 and/or any other device or module in communication with apparatus 100. In this regard, communication interface 140 may include, for example, supporting hardware and/or software for enabling communications with network 150, where network 150 may be any type of wired or wireless communications network.

Apparatus 100 may connect to one or more electronic devices, such as computers or servers, via communication interface 140 and network 150. FIG. 1 depicts apparatus 100 having a communications connection with data server 170, and search servers 180 and 190. In this regard, apparatus 100 may interface with data server 170 to store and/or retrieve data. Data server 170 may be any type of data server and may include one or more databases, spreadsheets, or the like that may be interfaced by apparatus 100. Apparatus 100 may interface with search servers 180 and 190 to perform data searches. Search servers 180 and 190 can be any type of servers capable of performing a query against data stored and connected to network 150. In some embodiments, search servers 180 and/or 190 can include search engines, search forms, or the like. The search engines, search forms, or the like, may include linkable data fields that may be used facilitate performing a search.

User interface 130 may be in communication with processing element 110 to receive an indication of a user input and/or to provide an audible, visual, mechanical or other output to the user. As such, user interface 130 may include, for example, a keyboard, a mouse, a joystick, a touch-screen display, a conventional display, a microphone, a speaker, or other input/output mechanisms.

In an exemplary embodiment, processing element 110 may include or otherwise control phrase generator 160, grammar identifier 162, and/or phrase parser 164. Phrase generator 160, grammar identifier 162, and/or phrase parser 164 may be any means or device embodied in hardware, software, or a combination of hardware and software that is configured to carry out the functions of phrase generator 160, grammar identifier 162, and/or phrase parser 164, respectively, as described herein. In various exemplary embodiments, Phrase generator 160, grammar identifier 162, and/or phrase parser 164 may be embodied at a server or other network device.

Phrase generator 160 may be, for example, a plug-in or other background application configured to operate cooperatively with grammar identifier 162 and various other applications to guide a user in defining a phrase. In this regard, for example, phrase generator 160 may be configured to receive information from a user via user interface 130, for example, and guide the user in defining a phrase.

Grammar identifier 162 may be configured to recognize various utilizations of language to assist phrase generator 160 in the development of a phrase, and assist phrase parser 164 in the parsing of a phrase. In this regard, grammar identifier 162 may be language specific. As such, according to various exemplary embodiments, grammar identifier 162 may be a software component that may be interchangeable depending on the targeted language.

Phrase parser 164 may be an application configured to parse a defined phrase into segments, derive information from the segments, link the segments to data fields, and perform one or more operations (e.g., searches, stores, or the like) with respect to a phrase. Phrase parser 164 may operate cooperatively with grammar identifier 162 and various other applications. In this regard, phrase parser 164 may be embodied at a server or other network device.

More particularly, phrase generator 160 may be configured to receive content from a user, and guide the user in defining a phrase on a segment-by-segment basis. A phrase may be defined within a single data entry field by inputting content into the data entry field. Upon inputting content, a user may begin to define a segment. Segments may be defined in various ways, and examples of defined segments are included below. In some exemplary embodiments, a segment may be defined when a unit of meaningful information is provided. For example, the entry of “flight,” “aisle seat,” “hotel,” “nonsmoking,” “view of downtown,” may be defined segments. As such, after a segment is defined, additional segments may be defined as the phrase is defined.

A phrase may include required and optional segments. Based on the context of the phrase, a particular segment type may become required as a user constructs a phrase. For example, with respect to an exemplary search for travel products, if a user inputs “I want a hotel,” segments indicating the location or date of stay may become required segments. In some exemplary embodiments, the inclusion of a particular segment may force the inclusion of a required subsequent segment.

Optional segments may be included to further describe the phrase. For example, in a search for travel products, if a user inputs “I want a nonsmoking hotel room in Paris on Friday,” the term “nonsmoking” may constitute a defined segment and may be optional since sufficient information may be otherwise provided to perform a reasonable search.

In some embodiments, assumed or default segments may be included in a phrase. Assumed or default segments need not be input by a user, and phrase generator 160 may append or otherwise associate the assumed or default segments with the phrase. The assumed or default segment may operate in the same manner as a segment that was input by a user. For example, consider a scenario where a user inputs the phrase “paris on Friday.” The phrase “paris on Friday” may appear to be an undefined phrase since it appears that additional information may be needed to execute a search. However, phase generator 160 may be configured to append or otherwise associate an assumed or default segment of “hotel” with phrases that include location and time information without further detail. As such, with the addition of the assumed or default segment (in this case “hotel”), sufficient content may be provided to perform a search or other operation. Accordingly, even though the assumed or default phrase may be used in completing an operation with respect to the phrase, the assumed or default segment need not be displayed or presented to the user in the data entry field. Thus, assumed and default segments may be used to define a phrase that may not have been defined in the absence of the assumed or default segment.

According to various exemplary embodiments, phrase generator 160 may make recommendations to a user to guide the user as a segment is defined. The recommendations may be conveyed to the user by phrase generator 160 via various means supported by user interface 130. In some exemplary embodiments, recommendations may be provided to a user in a list of recommendations. Phrase generator 160 may make recommendations for content of a segment. In this regard, recommendations provided by phrase generator 160 may be used to add content to an undefined segment, leaving the segment undefined, add content to an undefined segment to define the segment, add content to an undefined segment to define the segment and add content to a subsequent segment, or add content to define the segment and also define additional segments.

Phrase generator 160 may provide recommendations based on the content of other segments in the phrase and the context and content of an undefined segment. In some exemplary embodiments, recommendations may also be provided based on grammar rules provided by grammar identifier 162. Recommendations may also be based on the characters or other content that a user has begun to input as the phrase is being defined. Using these characters or other content, the recommendations may be narrowed to include those recommendations that incorporate some or all of the characters or content, provided by the user.

In some embodiments, a search for associated data that can be utilized in providing recommendations may be performed based on currently defined segments. The search may provide data that may be included in the recommendations, or eliminate recommendations that may have been included otherwise. For example, if a user has input “I want to go to Honolulu,” phase generator 160 may make date recommendations to define the next segment. However, prior to making date recommendations, a search of flights to Honolulu may be conducted. Using the results of the search, recommendations for dates may be provided for only those days that flights to Honolulu are available. Further, if the user had entered, “I want to go to Honolulu first class,” a search may be conducted and the results of the search may be utilized to provide for date recommendations including only the dates with flights to Honolulu having available first class seats.

Recommendations may include one or more associated match values. As a user inputs characters or other content to define a segment, the characters or other content can be compared against match values of the possible recommendations. The recommendations including match values that have the same characters or other content as those input by the user can be provided to the user as recommendations. For example, a recommendation of “Eurodisney” may include a match value of “Paris.” In this example, consider a scenario where a user inputs the characters “par.” “Eurodisney” may be included in a list of recommendations because “par” includes characters in “Paris” which is a match value for “Eurodisney.” As such, match values may be synonyms, acronyms, abbreviations, or any other collection of characters or content that has a defined relationship to the recommendation.

In some embodiments, ambiguous terms may be included in a segment causing additional description to be required. For example, if a user enters “Palm Beach,” this may refer to a hotel in Dubai, or the city in Florida. As such additional descriptive terms may be included in the recommendation to avoid ambiguity (e.g., by including selections for “Palm Beach, Fla.” and “Palm Beach Hotel, Dubai.”

Recommendations may include the actual content or a type of content that may be used as a segment is being defined. For example, a date segment, such as “on [DATE]” may be recommended, where the specific date is not provided as a recommendation, based on the context of a phrase targeting a search for a hotel. In response to providing recommendations, a user may select one of the recommendations by, for example, typing the recommendation or clicking on the recommendation, and the content of the recommendation may be input into the data entry field as the segment is being defined. Additionally, recommendations may be navigated and/or selected using a tab keys, arrow keys, return/enter keys, and/or the like.

Relative recommendations may also be provided. A relative recommendation may depend from a foundational value. For example, a recommendation of “this Friday” may be a relative recommendation. In this example, the foundational value is today's date and therefore “this Friday” relative to today's date can be used to define a segment. Other exemplary relative recommendations may include “this weekend,” “next Tuesday,” “as soon as possible,” etc.

Phrase generator 160 may also provide recommendations based on promotions. In this regard, a promotion may result in a recommendation being included that would not have been included otherwise. Further, a promotion may result in one or more recommendations being output at a more prominent location in a list of recommendations, for example, the beginning of the list, or in a more prominent manner, for example, in bold or with an icon. In this regard, promotions can be used for any of a variety of reasons. For example, if a flight to New York is currently on sale at a discount, when a user inputs content into the data entry field indicating that the user is interested in booking a flight, recommendations for completing a location segment may place New York in the first location on the list. As such, promotions may be used as a type of advertising or marketing device to entice a user to select a particular recommendation.

By selecting recommendations as a segment is being defined, phrase generator 160 may validate the content input by a user. In this regard, an error output may be provided when phrase generator 160 or grammar identifier 162 does not recognize the content that the user has input as the segment is being defined. According to various exemplary embodiments, phrase generator 160 can validate entire segments, portions of segments, and both. Similarly, as a phrase is being defined, phrase generator 160 may validate the entire phrase to ensure that required segments are provided. If a required segment is absent, and no assumption or default segment may satisfy the absence of a required segment, phrase generator 160 may prevent the phrase from being used in an operation. In this regard, where an undefined phrase is identified, phrase generator 160 may make recommendations to include the required segments needed to define the phrase.

According to some embodiments of the invention, the recommendations provided by phrase generator 160 may be provided without regard to any previously received phrase including the same defined segments. In this regard, in some embodiments, the recommendations may be based on the content of other segments in the phrase, the context and content of an undefined segment, but need not be based on received or defined phrases and defined segments that were used with respect to previous operations (e.g., searches, stores, or the like). For example, if “hotel in Paris on Friday” is entered and a search operation is performed, recommendations for another, subsequent search need not be determined based on the previously entered, received, or defined phrase and segments of “hotel in Paris on Friday.”

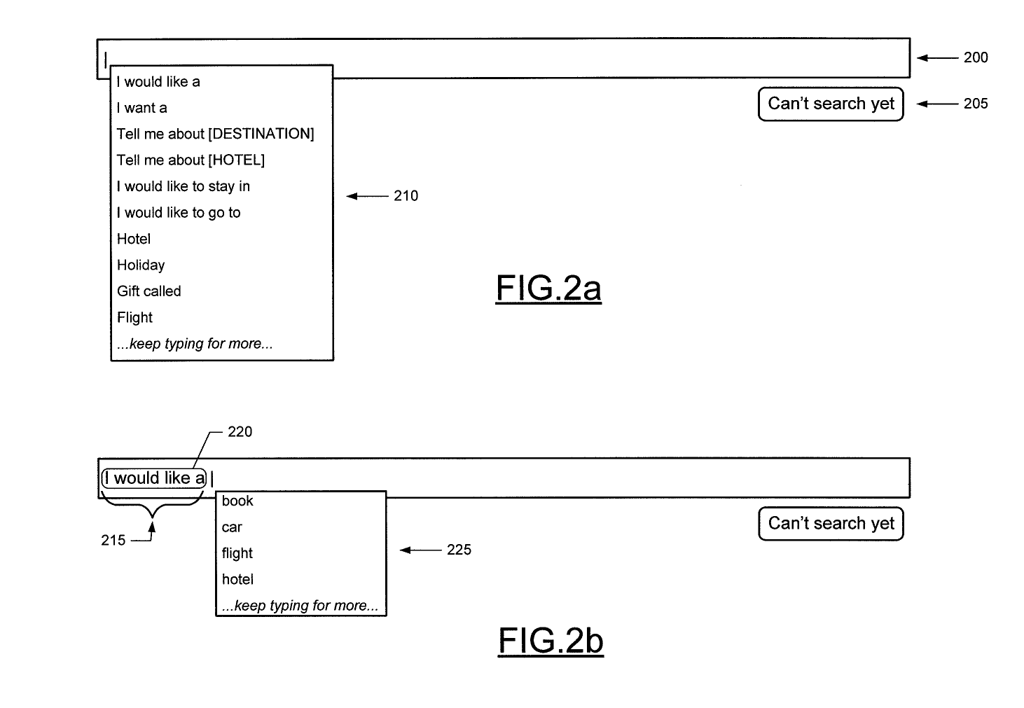

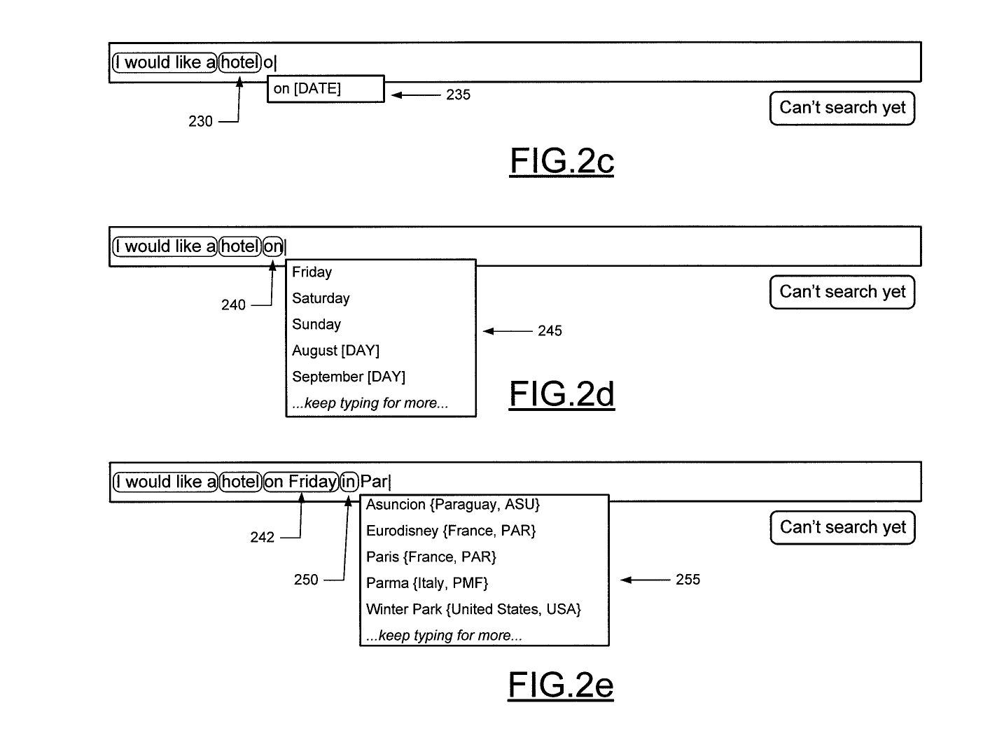

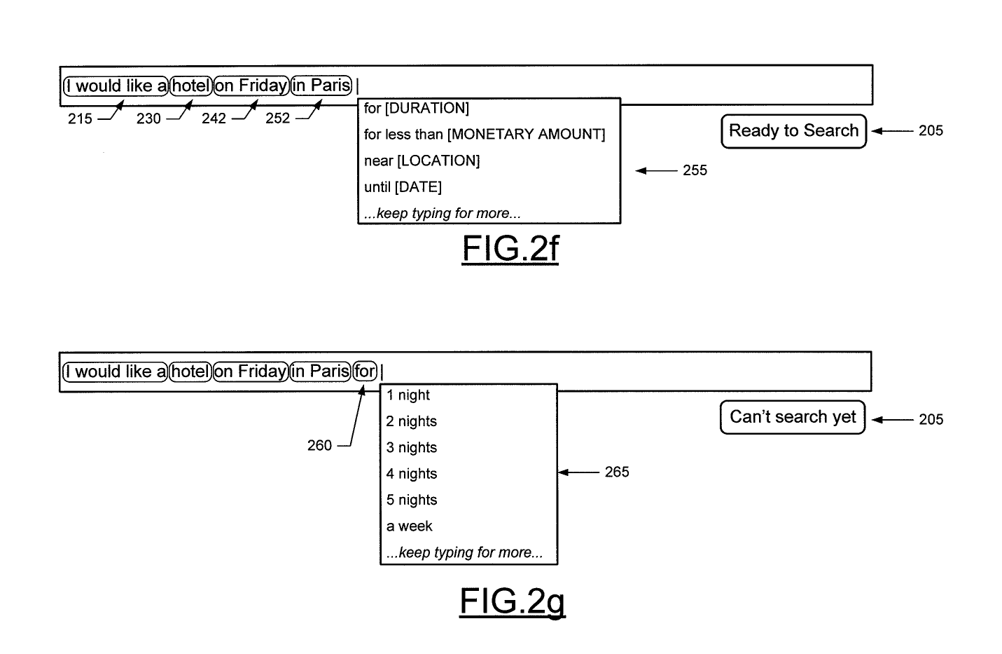

An exemplary embodiment of the present invention will now be described with reference to FIGS. 2a-2g, in which phrase generator 160 guides a user in defining an exemplary phrase, where the phrase is a sentence. FIGS. 2a-2g describe an exemplary embodiment and scenario where a phrase is generated as an exemplary sentence. It should be noted that phrase generator 160 may generate phrases that are not sentences in a linguistic sense. In this regard, phrases can be generated where the segments of the phrase continue to have a context with respect to the other defined segments. It should also be noted that while the exemplary embodiment described with respect to FIGS. 2a-2g is directed to a search for travel products, embodiments of the present invention may be directed generally to content entry in any context.

FIG. 2a includes content entry field 200, operation button 205 and list of recommendations 210. Content entry field 200 can be a freeform data entry field of a form, webpage, widget, frame, mobile phone application or the like that can receive content to facilitate performing operations based on the received content. Content entered into content entry field 200 can be used as input for querying or storing data in a local or networked database or other content storage and/or retrieval device. Operation button 205 may be selectable to initiate an operation with respect to the content within content entry field 200. Operation button 205 may also be configured such that when a phrase is not validated as a defined phrase as described above, operation button 205 can be deactivated, preventing operations, such as queries or storage operations, with respect to phrase contained within content entry field 200. Operation button 205 may also include an indicator that informs a user of the status, i.e. activated or deactivated, of the button. Referring to FIG. 2a, since no content has been input into content entry field 200, the phrase may not be defined, and as such validation of the phrase may fail. Accordingly, operation button 205 may be deactivated as indicated by the text “Can't search yet” labeled on the button.

In FIG. 2a, a user has not yet input any content into content entry field 200. However, even with no content entered, phrase generator 160 may make recommendations with respect to an undefined segment of a phrase to be input into content entry field 200. As such, list of recommendations 210 may be presented or displayed. In this regard, recommendations in the exemplary embodiment of FIGS. 2a-2g are provided in an exemplary pop-up list. The user may type an entry in the list, or select an entry via a mouse, keyboard, or keypad, for example, to append content to the segment. Some of the recommendations may be appended, in their entirety, as content to an undefined segment. For example, entries “I would like a” and “I want a” may be added in their entirety. However, some of the recommendations of list of recommendations 210 include portions that indicate the type of content that also may be included as the segment is being defined. For example, “Tell me about [DESTINATION]” and “Tell me about [HOTEL],” may not be added in their entirety, but the recommendations provide the user with information regarding ways in which the user may add additional content.

In some embodiments, list of recommendations 210 may be considered introductory recommendations. Introductory recommendations need not include grammatical objects (e.g., flight, hotel, Wednesday, $100, etc.) or modifiers of grammatical objects (aisle, first-class, nonsmoking, etc.), but may provide context to the phrase. In the exemplary embodiment of FIG. 2a, the introductory recommendations are the first recommendations provided with respect to a phrase being defined, but introductory recommendations need not be included in the first segment of a phrase.

In FIG. 2a, a user may select one of the recommendations from list of recommendations 210 to add content to the segment and the phrase. In the exemplary scenario included in FIGS. 2a-2g, presume the user selects “I would like a” at 215 from the list of recommendations, as shown in FIG. 2b. Upon entry of content, without regard to whether the segment is defined, phrase generator 160, in combination with grammar identifier 162, may validate the content. If the added content is found to be valid, phrase generator 160 can provide an indication to the user. In the exemplary embodiments of FIGS. 2a-2g, phrase generator 160 and grammar identifier 162 may indicate to the user that added content is valid by providing a circle 220 around the validated content.

In the exemplary embodiment, “I would like a” at 215 may constitute a defined segment. As such, a new list of recommendations 225 can be provided with respect to a new, undefined segment. The recommendations 225 can be provided based on the content and the context of the segment at 215, where, at this point, the undefined phrase includes one defined segment. The context with respect to the new, undefined segment may include the fact that the user has not yet identified the grammatical object of the phrase. As such, based on the content of the segment at 215 and the context with respect to the undefined segment list of recommendations 225 may be directed toward identifying the grammatical object of the phrase. In this regard, phrase generator 160 may determine that the recommendations should target identifying the grammatical object the user desires, rather than, for example, requesting a date. Since identifying the object that the user desires is likely to be necessary in order to perform an effective search, a segment that identifies the object may be a required segment. In this regard, phrase generator 160 may also consider that required segments are remaining when providing recommendations as described above.

As shown in FIG. 2b, presume the user has selected the “hotel” entry from list of recommendations 225 at 230. Having defined a segment that includes the term “hotel” at 230, recommendations for a new, undefined segment can be provided. With respect to defining the new, undefined segment, as shown in FIG. 2c, presume the user inputs the character “o” as the respective segment is being defined. As such, list of recommendations 235 provided by phrase generator 160, include recommendations that also begin with, or otherwise include, the character “o,” e.g., “on [DATE]”.

FIG. 2d illustrates that the user selected the “on [DATE]” recommendation from list of recommendations 235. As such, a portion of the content needed to define the segment has been input. Phrase generator 160 has validated the “on” portion of the segment, and has indicated the validation by circling “on” at 240. Phrase generator 160 may also provide list of recommendations 245 with regard to the undefined segment. Based on context of the segment, derived from the content of the other segments of the phrase, and the content of the undefined segment, phase generator 160 may make recommendations in list of recommendations 245 with respect to the date the user desires a hotel room.

FIG. 2e illustrates that the user selected “Friday” from list of recommendations 245 at 242. As indicated by the circle around the segment “on Friday,” phrase generator 160 may validate the segment and indicate to the user that the segment is recognized. FIG. 2e also illustrates that the user has input “in” at 250 into begin defining another segment (which was validated) and has also input the characters “Par.” Phrase generator 160 may provide list of recommendations 255 based on the characters “Par” provided by the user. Note that the recommendations within list of recommendations 255 need not include only recommendations that begin with “Par.” Rather, phrase generator 160 may provide recommendations that have various relationships with the content input by the user via match values. In this exemplary embodiment, phrase generator 160 may match the string of characters provided by the user against a match value including a country name (e.g., Paraguay), a city name (e.g., Paris, Parma, Winter Park), or a destination within a city (e.g., Eurodisney {France, PAR}). Further, a promotion may be included in the exemplary embodiment to include “Eurodisney” in situations where the context of the segment is directed to a location and the location is entered by the user using the characters for “Paris” or some subset of those characters.

In some embodiments, the ordering of recommendations may be provided for based upon various criteria, such as the popularity of the recommendation (i.e., how frequently the recommendation is selected), the context of the segment for use with the recommendation based on other defined segments, alphabetical ordering taking into account the characters that have been entered and received, or the like. For example, with respect to ordering based on popularity, if “Paris” is selected more frequently that “Paraguay,” “Paris” may be listed higher in a list of recommendations than “Paraguay.” Additionally, for example, with respect to ordering based on the context of the segment, “flights in June” may dictate a context for the next segment that puts “Paris” ahead of “Eurodisney,” while “hotels in June” may dictate a context that puts “Eurodisney” ahead of “Paris.”

FIG. 2f illustrates that the user selected “in Paris” at 252 to define the segment. Note that the phrase input into the content entry field is “I would like a hotel on Friday in Paris.” According to this exemplary scenario, phrase generator 160 may perform a validation on the phrase residing in the content entry field and determine that all required segments are included, and as a result the phrased is defined. The exemplary phrase may include the defined segments at 215, 230, 242, and 252. In response to determining that the phrase is defined, phrase generator 160 may activate operation button 205 and allow the user to perform a search against the phrase in the content entry field. The label on operation button 205 may indicate “Ready to Search” to inform the user that a defined phrase has been generated. With the phrase defined, and the operation button 205 activated, a user may select the operation button to perform a search based on the phrase.

Even though a defined phrase has been generated, one or more additional segments may continue to be added to further define the phrase. In some embodiments, as additional segments or portions of segments are added to a defined phrase, the phrase may revert back to being undefined as a result of the inclusion of an undefined segment including user input, or as a result of additional segments creating a need for additional required segments. Regardless of whether the phrase is defined, a list of possible additional types of segments (not depicted) may be output to the user to indicate any additional segments that may be provided. As such, even though phrase generator 160 may identify a defined phrase, phrase generator 160 may also provide recommendations to add additional content to the phrase. Referring to FIG. 2f, list of recommendations 255 may be provided by phrase generator 160 to guide the user in providing additional content to the phrase.

FIG. 2g illustrates that the user selected a recommendation that begins with “for.” As such the user has created an undefined segment, and therefore the phrase is no longer defined. In response to the added content, operation button 205 may be deactivated. Additionally, phrase generator 160 may provide list of recommendations 265 to add content to the segment and the phrase in order to define the segment and re-define the phrase.

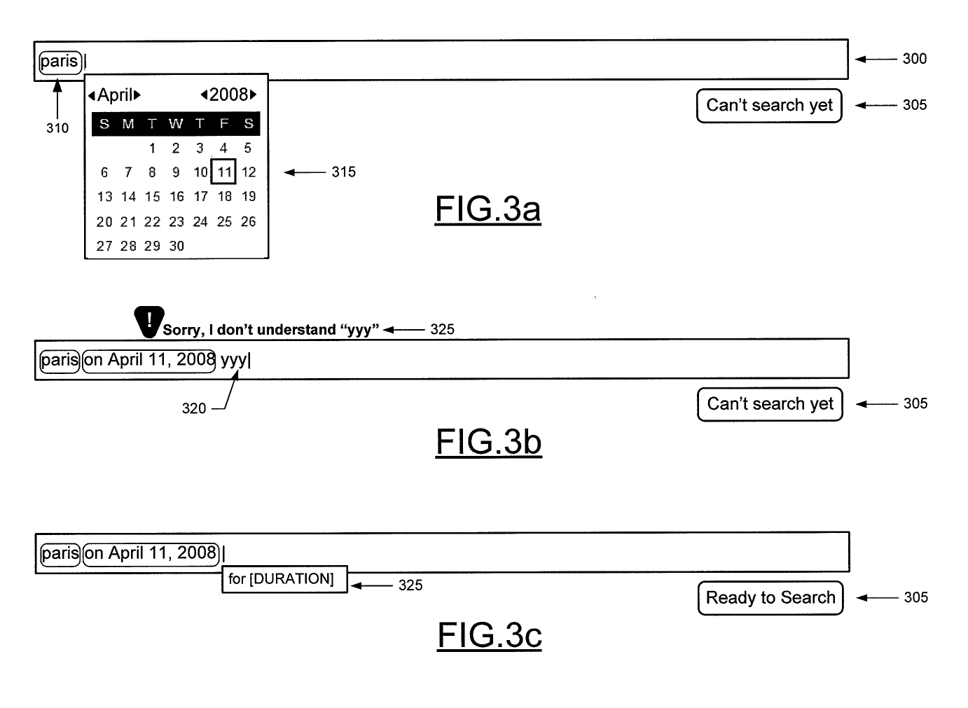

FIGS. 3a-3c describe an exemplary embodiment and scenario of the present invention where phrase generator 160 guides a user in the generation of phrase that is not a sentence. FIG. 3a illustrates that a user has input a first defined segment 310, i.e., “paris” into content entry field 300. After a validation check of the phrase, phrase generator 160 may determine that the phrase is undefined and the operation button 305 may be deactivated. Phrase generator 160 may provide calendar tool 315 to enter a date or date range. Calendar tool 315 may be provided by phrase generator 160 based upon the content of defined segment 310 and a context of a new, undefined segment. Since the user has indicated “paris” in the segment 310, the context of the undefined segment may indicate that a time frame with respect to the “Paris” segment may be recommended. As such, phrase generator 160 may provide calendar tool 315 in this regard.

FIG. 3b illustrates that the user selected Apr. 11, 2008 from the calendar tool 315. The user also input “yyy” at 320 to begin defining another segment. Phrase generator 160 may be unable to recognize “yyy” to provide recommendations and add content to the segment. As such, phrase generator 160 can provide an error message 325. As a result of phrase generator 160 being unable to recognize the content of the undefined segment, the operation button 305 can be deactivated. In some embodiments, error messages and the content that triggered the error message may be logged and analyzed to facilitate improvement in recognizing content input by a user.

FIG. 3c illustrates that the user removed the characters “yyy” from the undefined segment. As such, phrase generator 160 may perform a validation of the phrase to determine if the phrase is defined. In the exemplary embodiment of FIG. 3c, phrase generator 160 may identify a defined phrase, and operation button 305 can be activated. In some embodiments, the phrase may be defined in accordance with an assumed or default segment. The assumed or default segment indicating “hotel” may be utilized where the phrase contain a location segment and a date segment. Given the inclusion of the “hotel” segment, the phrase may be defined. Further, additional recommendations 325 may be provided even though the phrase is defined.

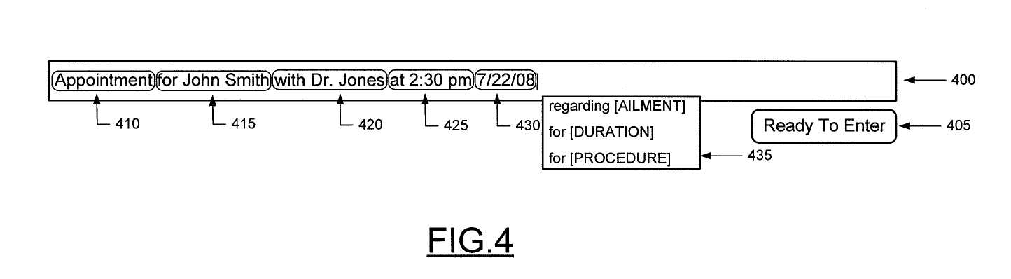

As described above, various embodiments of the present invention may guide a user in defining phrases that may to be used as queries. However, various embodiments of the present invention may also be used to guide a user in defining phrases for general data entry. FIG. 4 depicts an exemplary embodiment of the present invention where phrase generator 160 guides a user in defining a phrase to be used for general data entry.

In FIG. 4, a defined phrase may be input into content entry field 400. The phrase can be defined in a segment-by-segment basis as described above. The phrase of FIG. 4 contains segments 410, 415, 420, 425, and 430. According to this exemplary embodiment and scenario, the phrase may be used to enter content in the form of an appointment into an exemplary database, such as a calendar database. According to the exemplary embodiment of FIG. 4, the phrase may be a defined phrase, and no additional segments need be required before performing a storing operation may be performed. As such, operation button 405 can be activated, and a user may perform a storage operation with respect to the data within the phrase. The data may be stored in a local database or a database residing on a data server connected via a network, such as data server 170 of FIG. 1. As described above, even though a phrase may be defined, additional segments may be added to the phrase. As such list of recommendations 435 may be considered by the user if additional segments are to be added.

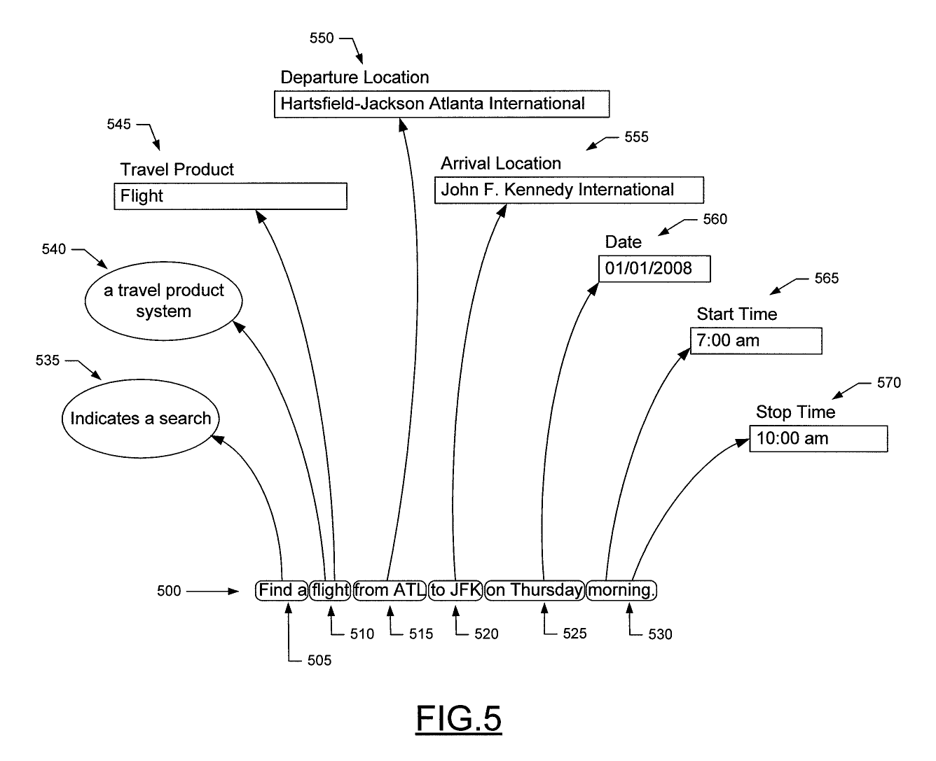

After a phrase has been defined by a user, with the guidance of phrase generator 160, phrase parser 164 may parse the phrase into one or more segments, derive information regarding the operation to be taken with respect to the phrase from the segments, and associate, or link, the content of the segments with data fields. Deriving information from the segments may reveal information regarding the type of operation that should be performed, a uniform resource locator (URL) that should be used to make a connection, or a category of that the phrase may be targeting, or the like. FIG. 5 depicts a parsed phrase 500 generated in accordance an embodiment of the present invention, where the segments are linked to data fields and/or information is derived from the segments. Linking content associated with a segment to a data field may include entering the associated content into the data field.

The exemplary data fields described with respect to FIG. 5 may reside on a target local or networked server, such as search servers 180, 190, and may be inputs, or search parameters, to a search engine. In this regard, the data fields may be associated with one or more target search engines, and as such results from one or more search engines may be retrieved through the use of the data fields.

Phrase 500 may be parsed by phrase parser 164 into segments 505, 510, 515, 520, 525, and 530. Information regarding the operation to be performed with respect to phrase 500 can be derived from, for example, segment 505. Segment 505 includes the content “Find a,” which may indicate to phrase parser 164 at 535 that a search may be performed. Information may also be derived from segment 510. Segment 510 includes the content “flight,” which may indicate a category and, when considered in context with the content of segment 505, may indicate that a travel product system should be searched with respect to flights at 540. Based on this information, phrase generator 160 may direct apparatus 100 of FIG. 1 to connect to one or more search servers 180, 190, in preparation to perform a search.

The content of segment 510 may also be linked to a data field 545, which includes a data field type of “travel product.” The content of segment 515, i.e., “from ATL” may be converted by phrase parser 164 to a flight departure location of Hartsfield-Jackson Atlanta International Airport. In order to perform such a conversion of the content of a segment, search values may be used. A search value may be provided when the user selected “ATL” from a recommendation during phrase generation. As such, in some embodiments, when a user selects a recommendation during generation of the phrase, a search value associated with the recommendation may be used to later convert the content of a segment during phrase parsing. As such, the content of segment 515 may be converted by removing the preposition “from” and converting “ATL” into “Hartsfield-Jackson Atlanta International.” This content can then be linked to a “departure location” data field 550. Similarly, the content of segment 520, i.e., “to JFK,” may be interpreted by phrase generator 160 to indicate a flight arrival location of John F. Kennedy International Airport. As such, the content of segment 520 may be conditioned by removing the preposition “to” and converting “JFK” into “John F. Kennedy International.” This content can then be linked to an “arrival location” data field 555.

The content of segment 525, i.e., “on Thursday” may be interpreted by phrase generator 160 to indicate a date the flight is to be scheduled. As such, the content of segment 525 may be converted by removing the preposition “on” and converting “Thursday” into a date format, e.g. “01/01/2008.” This content can then be linked to a “date” data field 560. The content of segment 530, i.e. “morning” may be interpreted by phrase parser 164 to indicate a general time the flight is to be scheduled. As such, the content of segment 530 may be converted from “morning” into a generally accepted timeframe for morning, e.g. 7:00 am to 10:00 am. As such, this content can be linked to a “start time” data field 565 and a “stop time” data field 570.

Upon connecting to the appropriate servers, if needed, and linking the content associated with the segments to various data fields, an operation can be performed with respect to the phrase, and results may be provided to, for example, apparatus 100. In the exemplary embodiment of FIG. 5, a search of one or more travel product systems can be performed based on criteria provided via the segments of the phrase. In some embodiments, a user may be redirected to a search engine results webpage that returns the results of the search. In this regard, the interface used to define the phrase, can operate as a front-end to one or more search or data servers, providing the user with a single entry access to one or more servers. Where more than one search server is queried, results from the multiple locations can be returned and aggregated.

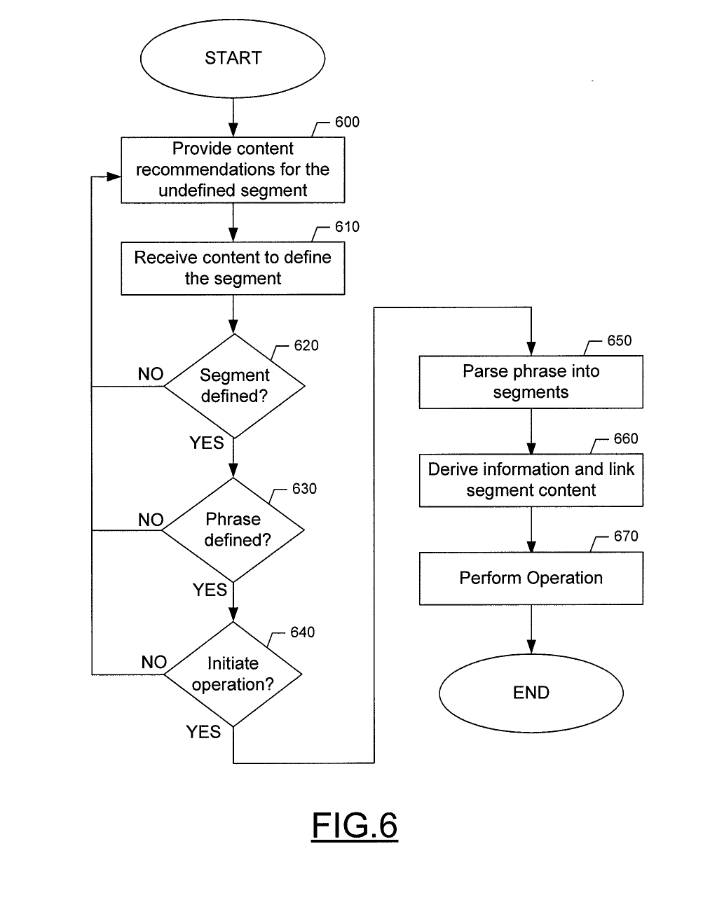

FIG. 6 is a flowchart of a system, method and program product according to exemplary embodiments of the invention. It will be understood that each block or step of the flowchart, and combinations of blocks in the flowchart, can be implemented by various means, such as apparatus 100, processing element 110, hardware, firmware, and/or software including one or more computer program instructions. For example, one or more of the steps described herein may be embodied by computer program instructions. In this regard, the computer program instructions which embody the steps described herein may be stored by a memory device and executed by a processor. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowchart of FIG. 6 may support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

As shown in FIG. 6, one exemplary embodiment of a method according to the present invention may include providing content recommendations for an undefined segment of an undefined phrase at 600. In some embodiments, one or more content recommendations for defining an undefined segment may be provided based on characters or other content provided by a user and a context determined from any previously defined segments of the phrase.

The exemplary method may also include receiving content to define a segment at 610. In this regard, content can be received from a user via selection of a recommendation as described herein. In some instances, recommendations may be received to thereby define the undefined segment of the phrase. The recommendations may also be provided without regard to any previously received phrase including the same one or more defined segments that may have included the same defined segment. In some embodiments, receiving content to define a segment at 610 can include receiving one or more characters or other content of the undefined segment, which may include one or more collections of characters having a user-defined meaning.

At 620, a validation of the segment can be performed to determine if the segment is defined. If the segment is not defined, additional recommendations can be provided at 600. If the segment is defined, then a validation of the phrase can be performed at 630. If the phrased is not defined due to, for example, an absence of a required segment, then additional recommendations may be provided at 600. If the phrase is defined, it can be determined whether the user would like to initiate an operation with regard to the phrase at 640. If the user, chooses not to initiate an operation, for example, to add additional segments to the phrase, additional recommendations may be provided at 600.

If the user chooses to initiate an operation, such as a search or a data storage operation, the phrase can be parsed into segments as described above at 650. After parsing the phrase, information may be derived from the content of the parsed segments, and content associated with the parsed segments can be linked to data fields at 660. The operation at 660 may also include connecting to target databases, such a search engines. At 670, an operation, such as a search or a data storage operation, may be performed.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
receiving one or more characters of an undefined segment of an undefined phrase, the undefined phrase including the undefined segment and one or more defined segments, each segment including one or more collections of characters having a user-defined meaning;
providing one or more recommendations for defining the undefined segment, the recommendations being selected based on the received one or more characters of the undefined segment and a context of the one or more defined segments in the phrase, the recommendations being provided without regard to any previously received phrase including the same one or more defined segments; and
receiving one of the recommendations to thereby define the undefined segment, the phrase thereafter including a plurality of defined segments.

2. A method according to claim 1 further comprising:
parsing the phrase into a plurality of segments; and
linking content associated with the one or more parsed segments to one or more data fields, the content being based on the one or more collections of characters.

3. A method according to claim 2 further comprising performing a search with a search engine, wherein the linked data fields are used as search parameters.

4. A method according to claim 2, wherein providing one or more recommendations includes providing one or more recommendations based on one or more match values.

5. A method according to 2, wherein linking content associated with the one or more parsed segments includes determining the data field associated with each segment based on the context and content of each segment within the phrase.

6. A method according to 2, wherein providing one or more recommendations includes providing recommendations based on a promotion.

7. A method according to 1 further comprising appending additional segments to the phrase to further define the phrase.

8. An apparatus comprising:
a processor configured to receive one or more characters of an undefined segment of an undefined phrase including the undefined segment and one or more defined segments, each segment including one or more collections of characters having a user-defined meaning;
wherein the processor is configured to provide one or more recommendations for defining the undefined segment, the recommendations being selected based on the received one or more characters of the undefined segment and a context of the one or more defined segments in the phrase the recommendations being provided without regard to any previously received phrase including the same one or more defined segment; and
wherein the processor is configured to receive one of the recommendations to thereby define the undefined segment and the phrase.

9. An apparatus according to claim 8, wherein the processor is further configured to parse the phrase into one or more segments; and wherein the processor is further configured to link content associated with the one or more parsed segments to one or more data field, the content being based on the one or more collections of characters.

10. An apparatus according to claim 9, wherein the processor is further configured to perform a search using the linked data fields as search parameters.

11. An apparatus according to claim 9, wherein the processor being configured to provide one or more recommendations is further configured to provide one or more recommendations based on one or more match values.

12. An apparatus according to claim 9, wherein the processor being configured to link content associated with the one or more parsed segments includes being configured to determine the data field associated with each segment based on the context and content of each segment within the phrase.

13. An apparatus according to claim 9, wherein the processor being configured to provide one or more recommendations includes being configured to provide recommendations based on a promotion.

14. An apparatus according to claim 8, wherein the processor is further configured to append additional segments to the phrase to further define the phrase.

15. A computer-readable storage medium having computer-readable program code portions stored therein, the computer-readable program code portions comprising:
a first executable configured to receive one or more characters of an undefined segment of an undefined phrase including the undefined segment and one or more defined segments, each segment including one or more collections of characters having a user-defined meaning;
a second executable portion configured to provide one or more recommendations for defining the undefined segment, the recommendations being selected based on the received one or more characters of the undefined segment and a context of the one or more defined segments in the phrase the recommendations being provided without regard to any previously received phrase including the same one or more defined segment; and
a third executable portion configured to receive one of the recommendations to thereby define the undefined segment and the phrase.

16. A computer-readable storage medium according to claim 15 wherein the program code portions further comprise:
a fourth executable portion configured to parse the phrase into one or more segments; and
a fifth executable portion configured to link content associated with the one or more parsed segments to one or more data field, content being based on the one or more collections of characters.

17. A computer-readable storage medium according to claim 16 wherein the program code portions further comprise a sixth executable portion configured to perform a search using the linked data fields as search parameters.

18. A computer-readable storage medium according to claim 16 wherein the second executable portion being configured to provide one or more recommendations includes being configured to provide one or more recommendations based on one or more match values.

19. A computer-readable storage medium according to claim 16, wherein the fifth executable portion being configured to link content associated with the one or more parsed segments includes being configured to determine the data field associated with each segment based on the context and content of each segment within the phrase.

20. A computer-readable storage medium according to claim 16, wherein the second executable portion being configured to provide one or more recommendations includes being configured to provide recommendations based on a promotion.

21. A computer-readable storage medium according to claim 15 further comprising a fourth executable portion configured to append additional segments to the phrase to further define the phrase.
